(19) United States
(12) Patent Application Publication
(10) Pub. No.: US 2014/0048579 A1
(43) Pub. Date: Feb. 20, 2014

(54) LOCATION MARKING DEVICE

(71) Applicants: Patrick Thompson, Springfield, CO (US); Robert Moore, Springfield, CO (US)

(72) Inventors: Patrick Thompson, Springfield, CO (US); Robert Moore, Springfield, CO (US)

(21) Appl. No.: 13/961,009

(22) Filed: Aug. 7, 2013

Related U.S. Application Data
(60) Provisional application No. 61/682,798, filed on Aug. 14, 2012.

(51) Int. Cl. G01C 15/02

(52) U.S. Cl. CPC G01C 15/02
USPC 227/140

(57) ABSTRACT

A location marking device is disclosed. An example location marking device includes a drive tube to receive a wire of a marker flag to be installed. The location marking device also includes a plunger rod slidably held within the lumen of the drive tube and operable between a passive state and an active state. The location marking device also includes a handle provided to a proximal end of the plunger rod and movable toward and away from a proximal end of the drive tube. The location marking device also includes a return rod extending from the handle towards a distal end of the drive tube. The location marking device also includes a resilient member configured to bias the plunger rod in the passive state.

### PRIORITY CLAIM

This application claims priority to U.S. Provisional Patent Application No. 61/682,798 filed Aug. 14, 2012, hereby incorporated by reference in its entirety as though fully set forth herein.

### BACKGROUND

Marker flags are often used to identify underground pipelines and electrical conduits, for example, to avoid damage during excavation of buried gas lines, water lines, phone lines, cable lines, fiber optic lines, and electrical lines. Marker flags may be used for other purposes as well, such as to mark property lines, trenching, irrigation, and other uses. Marker flags are typically made of a colored, weather-resistant material (e.g., plastic) that is mounted to a wire. It is often difficult to press a marker into the ground, as the wire may bend or even poke and cause injury to the installer. Furthermore, the installer has to bend over repeatedly to press each wire into the ground, which may result in back pain or other discomfort.

### BRIEF DESCRIPTION OF DRAWINGS

FIG. 1 illustrates a perspective view of a first example location marking device.

FIG. 2 illustrates a side view of the example location marking device.

FIG. 3 illustrates a front view of the example location marking device.

FIG. 4 illustrates a perspective view of another example location marking device.

FIG. 5 illustrates a side view of the other example location marking device.

FIG. 6 illustrates a front view of the other example location marking device.

FIG. 7 illustrates a detail view of return system of an example location marking device.

FIG. 8 illustrates a detail view of loading port of an example location marking device.

FIGS. 9-11 illustrate loading of an example marker flag into an example location marking device.

FIGS. 12-13 illustrate actuation of an example location marking device to install a marker flag into a surface.

FIG. 14 illustrates a marker flag installed into a surface by the example location marking device.

FIGS. 15-17 illustrate insertion of an example marking flag into an example location marking device.

FIG. 18 illustrates a perspective view of an example location marking device including colorant marking and global positioning subsystems.

FIG. 19 illustrates a side view of the example location marking device.

FIG. 20 illustrates a front view of the example location marking device.

### DETAILED DESCRIPTION

A location marking device is described herein as it may be embodied as a marker flag installation tool and marking system to facilitate marking locations and boundaries. The example location marking device may insert marker flags into a variety of surfaces (even tough ground) without damaging the marker flags, and can be used with a variety of different types of markers, including flags mounted on wire. The location marking device may be lightweight, reduces or altogether eliminates excessive bending or squatting by the installer, thereby reducing or altogether preventing discomfort or injury to the user.

Before continuing, it is noted that as used herein, the terms “include” and “including” mean, but are not limited to, “includes” or “including” and “includes at least” or “including at least.” The term “based on” means “based on” and “based at least in part on.”

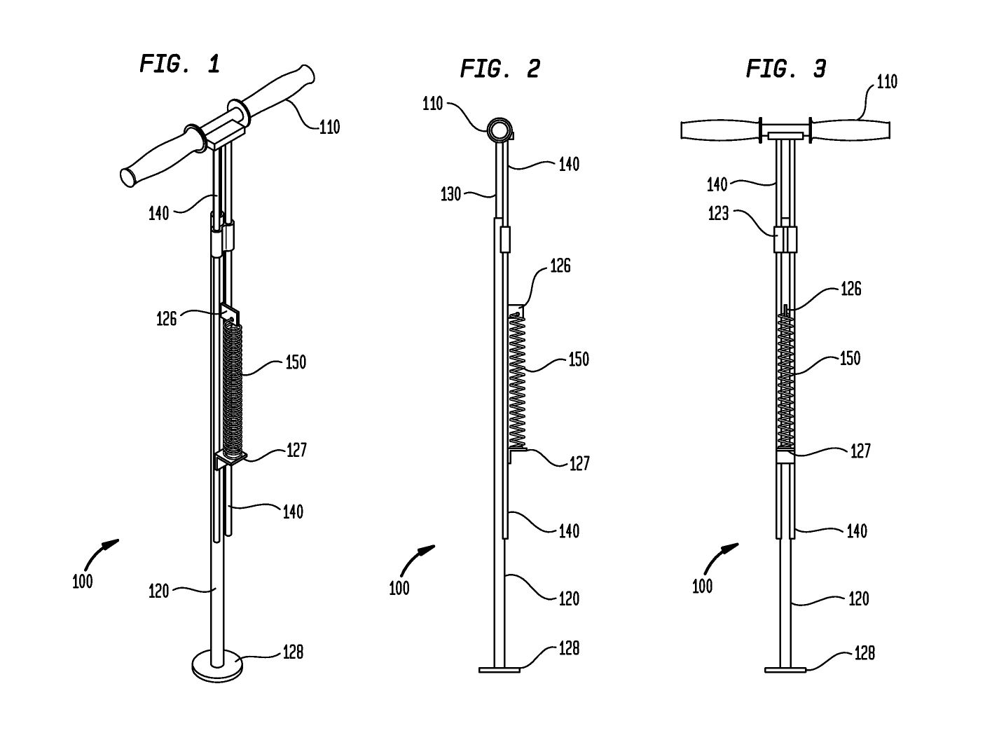

FIGS. 1-3 illustrate an example location marking device 100, wherein FIG. 1 is a perspective view, FIG. 2 is a side view, and FIG. 3 is a front view. The location marking device 100 is shown as it may include a handle 110, and a drive tube 120 to receive a wire 500 (see FIG. 13) or other support rod of a marker flag to be installed in a surface such as the ground. The location marking device 100 may also include an insertion rod or plunger rod 130 slidably held or configured within the drive tube 120. The handle 110 is arranged to or otherwise provided to operate the plunger rod 130 via an actuator assembly by moving toward and away from drive tube 120 to actuate the insertion rod 130 between passive and active states.

In an example, the plunger rod 130 may be removed and replaced with a different type, size, or shape of plunger rod. For example, different plunger rods may be provided to accommodate different width and/or length marker flags.

Return rods 140 are oriented or extend from handle 110 towards the drive tube 120 and are guided by a return rod guide 123 mounted to an exterior of drive tube 120. Return rods 140 may be approximately parallel to one another, and approximately parallel with plunger rod 130 and drive tube 120. However, other configurations may be provided to achieve different results.

In an example, a single return rod is provided, while in other examples two or more return rods may be provided. An example including two or more return rods may guide all rods by a single return rod guide, by a number of conjoined return rod guides, or each return rod may be guided by an individual return rod guide.

A resilient member, such as a spring 150, is configured to bias insertion rod 130 to a passive state in which the distal end (not visible) of plunger rod 130 is spaced apart proximally from the distal end of drive tube 120 by more than the length of a marker flag to be installed. A first end of the spring 150 may be anchored at a flange 127 near one end of the return rods 140 and a second end of the spring 150 may be anchored to a flange 126 at an exterior of drive tube 120. Any of a variety of resilient members may be utilized, including but not limited to, wave springs, extension springs, compression springs and torsion springs.

Due to operative coupling of the handle 110, insertion rod 130, and guide rods 140, biasing the insertion rod 130 by spring 150 also effectively biases return rods 140 towards the proximal end of the drive tube 120.

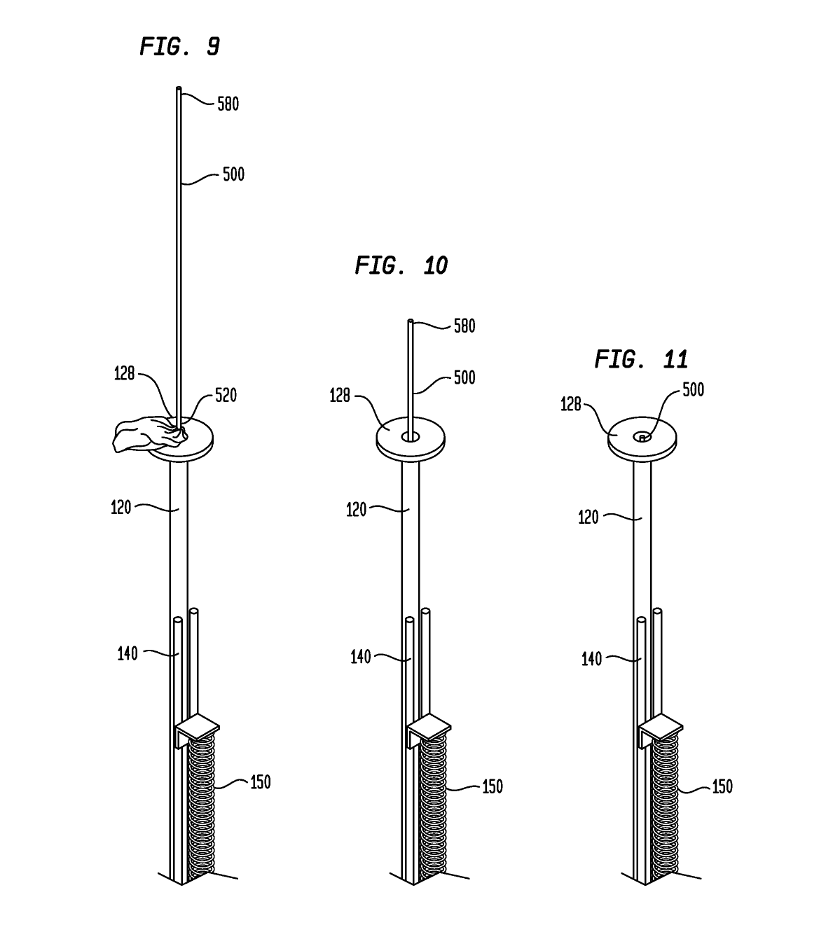

During use, movement of handle 110 towards a distal end of the drive tube 120 causes a distal end (not visible) of the insertion rod 130 to move from being spaced from a wire 500 of the marker flag being held within a lumen of the drive tube 120, to contacting the wire 500 of the marker flag at the wire end (see flag portion 520 in FIG. 9).

In an example, the drive tube 120 further comprises a flared distal end 128 configured to impede penetration into the surface (e.g., the ground) such that the wire 500 of a marker flag can be inserted at a desired or predetermined height, without unnecessarily sending the drive tube 120 into the ground during operation.

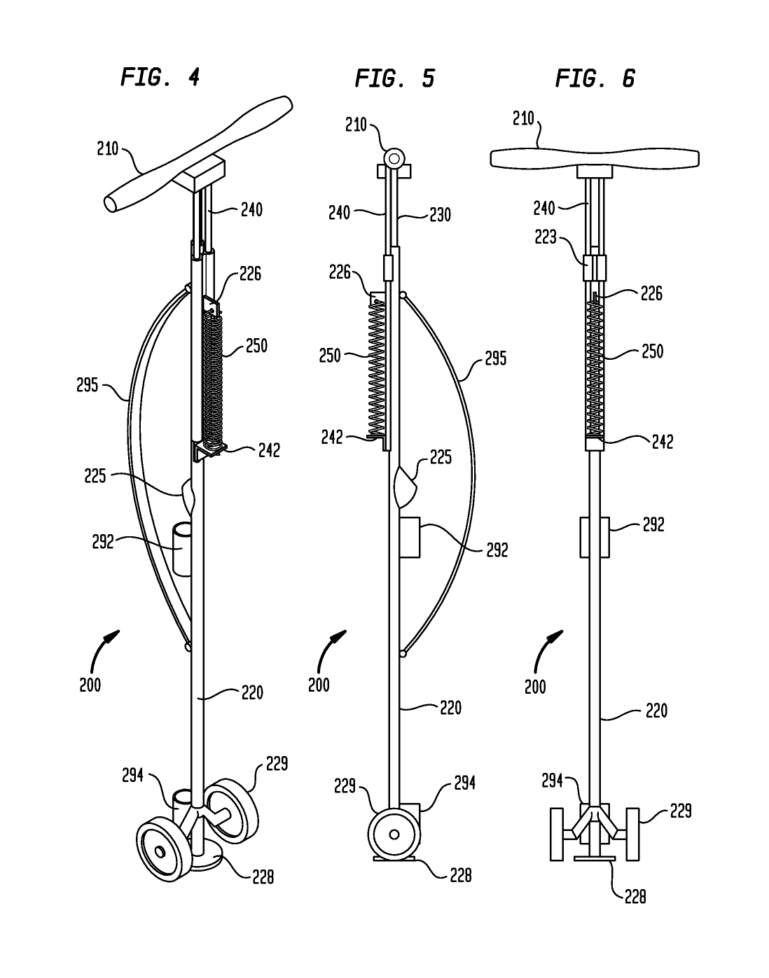

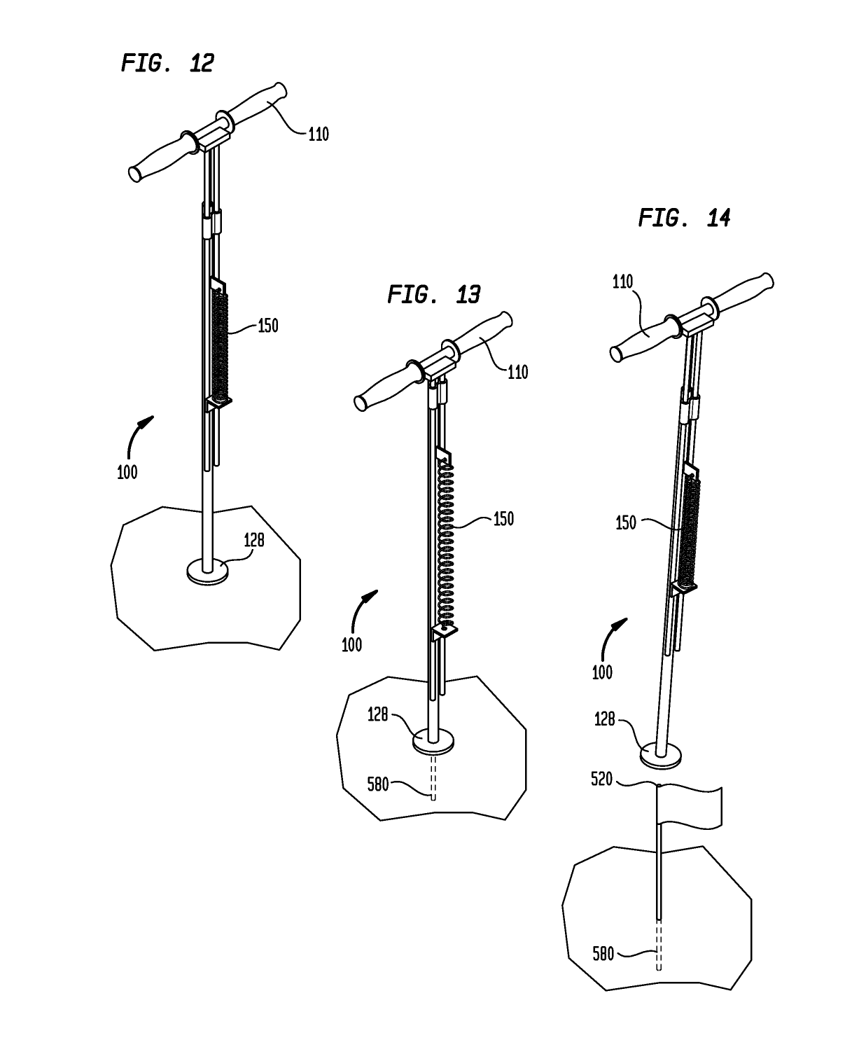

FIGS. 4-6 illustrate an example location marking device 200, wherein FIG. 4 is a perspective view, FIG. 5 is a side view, and FIG. 6 is a front view. Location marking device 200 is shown as it may include a handle 210, and a drive tube 220 having a lumen configured to receive a wire 500 (see FIG. 12) of a marker flag to be installed. An insertion rod or plunger rod 230 is slidably held within a lumen of the drive tube 220. Handle 210 is provided to a proximal end of the plunger rod 230 and is movable toward and away from a proximal end of the drive tube 220 to actuate plunger rod 230 between passive and active states.

Return rods 240 extend from handle 210 towards a distal end of the drive tube 220 guided by a return rod guide 223 mounted to an exterior of drive tube 220. Return rods 240 may be approximately parallel to one another, as well as parallel with insertion rod 230 and drive tube 220. Other configurations may be provided to achieve different results.

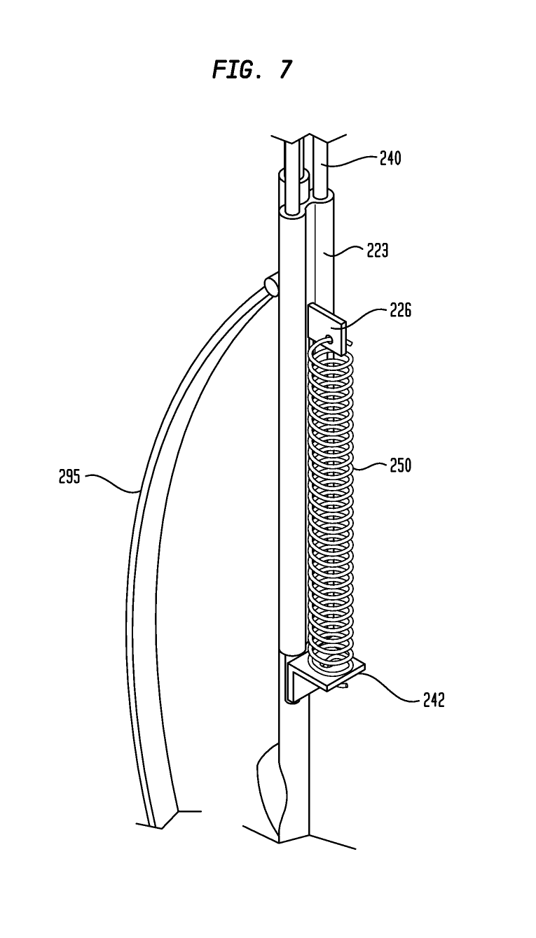

A spring 250 (or other biasing mechanism) is configured to bias plunger rod 230 to a passive state. FIG. 7 shows a close-up view of the spring assembly 250. A first end of the spring 250 may be anchored through a hole in a return flange 226 at one end of return rods 240, and a second end of the spring 250 may be anchored through a hole in a tube flange 242 at an exterior of drive tube 220.

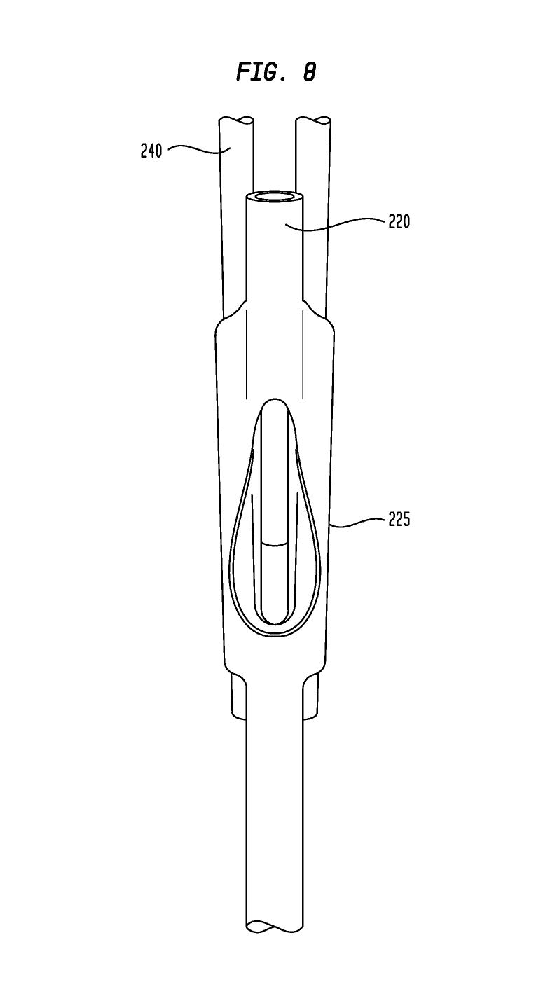

In an example, a marker rod loading port 225 on an exterior of the drive tube 220 provides an opening for outside entry into the lumen of drive tube 220. FIG. 8 shows a close-up view of the loading port 225. As such, the user does not have to turn the location marking device 200 over to insert a marker flag from the bottom, and instead can load the marker flags directly into the drive tube 220 via loading port 225. Loading port 225 may be provided at any distance along the length of drive tube 220, e.g., according to a length of the wire 500 of a marker flag to be installed.

In a passive state, handle 210 is spaced apart from drive tube 220 and a distal end of the plunger rod 230 is proximal to loading port 225. In an active state, plunger rod 230 extends distally beyond loading port 225 and contacts any marking rod provided in the drive tube 220. A distance between the return flange 226 and tube flange 242 is greater in the active state than in the passive state such that tension in spring 250 applies a force tending to restore handle 210, plunger rod 230 and restoring rods 240 to the passive state. With continued distal movement of handle 210, a distal end of the insertion rod 230 pushes the wire 500 held within the lumen of drive tube 220 out of the distal end of drive tube 220.

In an example, a cup 294 may be provided to hold marker flags when not in use. A stabilizer 292 may also be provided such that cup 294 supports the base of one or more marker flags adjacent to an exterior of the drive tube 220, and the stabilizer 292 maintains the marker flags approximately parallel with drive tube 220. Markers may be readily withdrawn in preparation for insertion through loading port 225.

In an example, the drive tube 220 has a flared distal end 228 configured to impede penetration into the surface (e.g., the ground) such that the wire 500 of a marker flag can be inserted at a desired or predetermined height, without unnecessarily sending the drive tube 220 into the ground during operation.

In an example, the In another example, location marking device 200 may include a handle or strap to facilitate a user lifting and carrying the location marking device 200. In addition, the drive tube 220 may also have a wheel assembly 229 to enable a user to more readily move the location marking device 200 (e.g., without having to lift and carry the location marking device 200).

It is noted that while provision of a handle on the insertion rod of location marking device 100 and 200 described above may enable manual activation of the insertion mechanism. In another example, however, the location marking device 100 and/or 200 may include means for automatic actuation (e.g., via pressurized air, hydraulics, electric motor, or gas engine).

It is also noted that the location marking device 100 and 200 described above may be made of any suitable materials, such as metal (e.g., lightweight aluminum), and/or sturdy plastic or other composite. In addition, the location marking device 100 and/or 200 may have any suitable dimensions. In an example, the drive tubes may be made of tubing having about a one-half inch outer diameter and a three-eighths inch inner diameter. Insertion rods may be five-sixteenth inch diameter. It should be noted, however, that marker flag installation tools 100 and 200 are not limited to any specific dimensions.

Before continuing, it should be expressly understood that examples described above are provided for purposes of illustration, and are not intended to be limiting. Other devices and/or device configurations may be utilized to carry out operations described herein.

FIGS. 9-11 illustrate insertion or loading an example marker flag into an example location marking device (e.g., device 100 shown in FIG. 1). With handle 110 spaced apart from proximal end 122 of drive tube 120 such that insertion rod 130 is in a passive state, a marker rod 500 can be inserted with a top or “flag” end 520 into a distal end of the drive tube 120 (e.g., until a bottom end 580 is near a distal end of the drive tube 120, as illustrated successively from FIG. 9 to FIG. 10 to FIG. 11. Once loaded, the marker flag is ready to be inserted into a surface such as the ground using the example location marking device.

FIGS. 12-14 illustrate actuation of an example location marking device to install a marker flag into a surface such as the ground. After loading the marker flag into the drive tube 120 (as just described above with reference to FIGS. 9-11), the location marking device 100 is held at a desired insertion angle (e.g., generally upright), as shown in FIG. 12. The distal end of the drive tube 120 is below the proximal end of the drive tube 120 and flared distal end 128 contacts the installation surface (e.g., the ground).

A small force is applied to handle 110 to overcome the bias of spring 150 and abut a distal end of the insertion rod 130 to a top end of the marker wire 500, as shown in FIG. 13. Increasing this force pushes a bottom end 580 of the marker wire 500 beyond a distal end of the drive tube 120 and into the surface of the ground. When a distal end of the marker wire 500 has penetrated the installation surface to a desired depth, the handle 110 can be released and automatically returns to a starting position under the force of biasing spring 150. The location marking device 100 can then be lifted to reveal the marker flag 520 installed in the surface, as shown in FIG. 14.

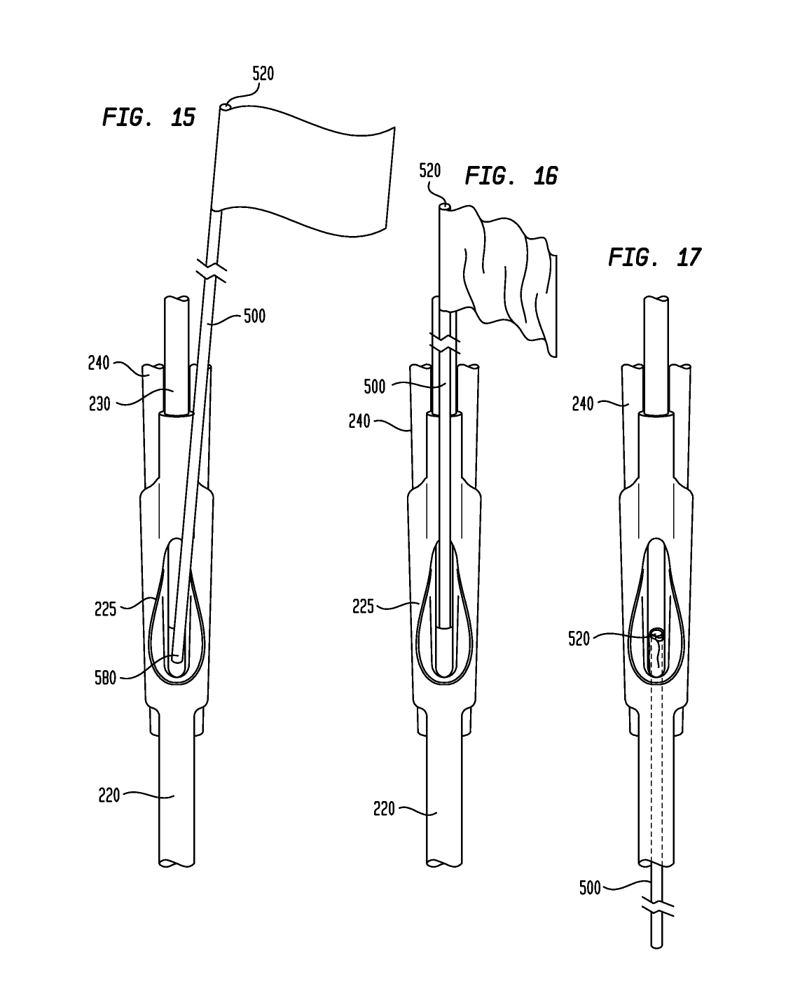

FIGS. 15-17 illustrate inserting or loading an example marker flag into an example location marking device (e.g., device 200 shown in FIG. 4). With handle 210 spaced apart from a proximal end of the drive tube 220 such that insertion rod 230 is in a passive state with its distal tip proximal to the marker loading port 225, a wire 500 of the marker flag is inserted through marker loading port 225 and into the lumen of the drive tube 220 (e.g., bottom end 580 first). In an example, the flag portion 520 may remain outside of the port 225 until actuation. In another example, the flag portion 520 may be inserted fully through port 225 prior to actuation. Installation of marker wire 500 into the installation surface can be effected in a manner similar to that described above with reference to FIGS. 12-14.

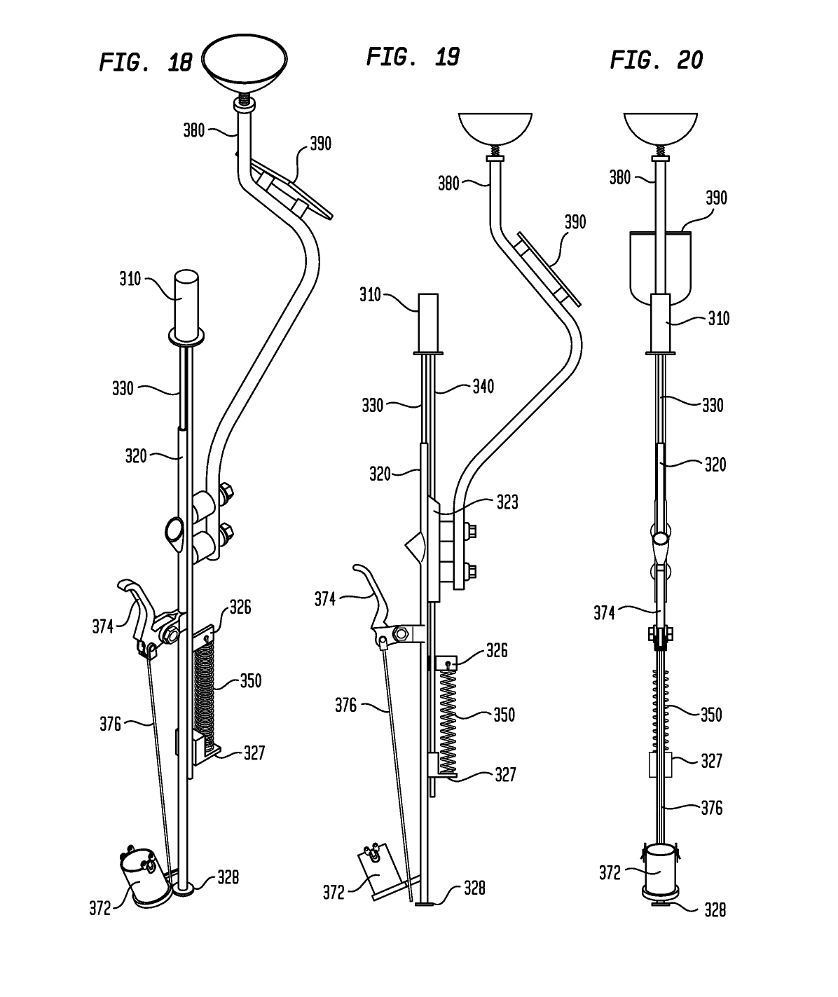

FIGS. 18-20 illustrate an example location marking device 300, wherein FIG. 18 is a perspective view, FIG. 19 is a side view, and FIG. 20 is a front view. The location marking device 300 is shown as it may include colorant marking and global positioning subsystems. As described above for location marking devices 100 and 200, the location marking device 300 may include a handle 310, and a drive tube 320 having a lumen configured to receive a marker flag to be installed. An insertion rod or plunger rod 330 is slidably held within a lumen of the drive tube 320 and is operative between passive and active states. The handle 310 is provided on a proximal end of the insertion rod 330 and is movable toward and away from a proximal end of the drive tube 320. Return rods 340 extend from handle 310 towards a distal end of the drive tube 320 and may be guided by return rod guides 323.

A resilient member such as a spring 350 is configured to bias insertion rod 330 in a passive state in which a distal end of the spring 350 is spaced apart from the distal end of the drive tube 320 by approximately the depth a marker flag is to be installed below the surface of the ground. In an example, a first end of the spring 350 is anchored at one end of return rods 340 at a flange 326 and a second end of spring 350 is anchored at an exterior of drive tube 320 at a flange 327.

Installation of a marker rod 500 into installation surface using handle 310, drive tube 320, insertion rod 330 and guide rods 340 proceeds in a manner similar to that described above with respect to FIGS. 12-14 above. For example, handle 310 may be depressed toward a distal end of the drive tube with sufficient force to engage and push marker wire 500 into the installation service to the desired depth. System 300 may allow for insertion of a marker rod 500 into drive tube distal end (similar to location marking device 100), through a loading port (similar to location marking device 200), or both.

The location marking device 300 may include attachments, such as a colorant marking subsystem and/or a global positioning subsystem (GPS). Other subsystems (mechanical and/or electronic) may also be implemented with the location marking device described herein.

In an example, the colorant marking subsystem may include a support 372 mounted to an exterior of drive tube 320 and configured to hold a dispenser (e.g., a spray can) of colorant. A trigger 374 may be configured to automatically and selectively dispense colorant from the dispenser held in support 372.

The colorant marking system may be used to apply marking colorant such as a dye, pigment, ink, or paint to a surface. A marking colorant dispenser is placed within support 372 provided to exterior surface of drive tube 320, and the marking system 300 is held generally upright. A trigger 374 mounted to exterior surface of drive tube 320 proximal to and remote from marking colorant dispenser is actuated to contact a colorant dispenser button and cause marking colorant to be expelled onto surface to be marked.

A global positioning system mount 380 is provided to include a sleeve configured for selective engagement of an exterior of drive tube 320 and an appendage configured to support a global positioning system 390. The GPS 390 may be permanently affixed as shown in the drawing, and/or a hand held component the user can place within a holder (shown on the end of mount 380). The holder may include a cover (not shown), e.g., in a dome or an “egg-shell” for holding the GPS 390.

In an example, the global positioning system may be mounted prior to beginning use of location marking device 300. With a global positioning system held to location marking device 300, a user may review coordinates or waypoints of marking locations or other information of interest for a surface that is to be marked. When a user determines location marking device 300 is in a location designated by coordinates or waypoints, the marker wire 500 may be installed as already described above. Visual and/or audio signals may indicate to the user when the location marking device 300 is in the appropriate position to insert the marker flag.

The operations shown and described herein are provided to illustrate example implementations. Operations are not limited to ordering shown. Still other operations may also be implemented.

It is noted that the location marking device described herein may be used to apply markings for any of a wide variety of purposes, including but not limited to identifying buried gas lines, water lines, phone lines, cable lines, fiber optic lines or electrical lines or marking property lines, trenching or irrigation. The location marking device 300 may also be used by surveyors, construction workers, Forest Service, state and federal highway workers, landscaping companies, schools, sports complexes, and by anyone else who desires to install a marker flag in ground or other surface.

It is noted that examples shown and described are provided for purposes of illustration and are not intended to be limiting. Still other examples are also contemplated.

1. A location marking device, comprising:
a drive tube to receive a wire of a marker flag to be installed;
a plunger rod slidably held within a lumen of the drive tube and operable between a passive state and an active state;
a handle provided to a proximal end of the plunger rod and movable toward and away from a proximal end of the drive tube;
a return rod extending from the handle towards a distal end of the drive tube; and
a resilient member configured to bias the plunger rod in the passive state.

2. The location marking device of claim 1, wherein a first end of the resilient member is anchored at one end of the return rod and a second end of the resilient member is anchored on an exterior of the drive tube.

3. The location marking device of claim 1, wherein applying a force to the handle acts against the resilient member to place the plunger rod in the active state.

4. The location marking device of claim 1, wherein a length of the resilient member is greater in the active state than in the passive state.

5. The location marking device of claim 1, further comprising a return guide mounted to an exterior of the drive tube and configured to guide the return rod between the passive state and the active state.

6. The location marking device of claim 1, wherein the drive tube has a flared distal end to impede penetration of the drive tube into a surface.

7. The location marking device of claim 1, further comprising a loading port in the drive tube to receive the wire of the marker flag in the lumen of the drive tube.

8. The location marking device of claim 7, wherein in the active state, the plunger rod extends distally beyond the loading port.

9. The location marking device of claim 7, wherein, in the passive state, a distal end of the plunger rod is proximal to the loading port.

10. The location marking device of claim 1, wherein movement of the handle towards a distal end of the drive tube causes the plunger rod to push the wire of the marker flag out of the drive tube and a predetermined distance past a surface of ground.

11. A system for location marking comprising:
a drive tube configured to receive a wire of a marker flag to be installed in ground;
an plunger rod slidably held within a lumen of the drive tube and operable between a passive state and an active state;
a handle provided on a proximal end of the plunger rod, the handle movable toward and away from a proximal end of the drive tube; and
at least one return rod extending from the handle towards a distal end of the drive tube.

12. The marking system as set forth in claim 11, further comprising a spring configured to bias the at least one return rod towards a proximal end of the drive tube.

13. The system of claim 11, further comprising a global positioning system mount.

14. The system of claim 11, a support mounted to the drive tube to hold a dispenser of marking colorant.

15. The system of claim 14, further comprising a trigger configured to selectively dispense colorant from a dispenser held in the support.

16. The system of claim 11, further comprising a cup and a stabilizer configured to support and stabilize at least one marker rod adjacent to and parallel with the drive tube.

17. The marker installation tool as set forth in claim 11, further comprising a wheel assembly detachably mounted near a distal end of drive tube.

18. The marker installation tool as set forth in claim 11, further comprising a carrying strap on an exterior of the drive tube.

19. A method of marker flag installation, comprising:
providing a drive tube sized to receive a wire of the marker flag to be installed;
slidably configuring a plunger rod within the drive tube;
orienting at least one return rod towards a distal end of the drive tube; and
biasing an actuator in a passive state spaced apart from drive tube proximal end.

20. The method of claim 19, further comprising releasing the actuator from the passive state to insert the wire of the marker flag into a surface, wherein the actuator automatically returns to a passive state after inserting the wire into the surface.
